(19) United States
(12) Patent Application Publication
(10) Pub. No.: US 2026/0302173 A1
(43) Pub. Date: Oct. 1, 2026

(54) METHOD FOR PRODUCING POSITIVE ELECTRODE FOR SECONDARY BATTERIES

(71) Applicant: HONDA MOTOR CO., LTD., Tokyo (JP)

(72) Inventors: Hiroto MAEYAMA, Saitama (JP); Naoya KAMEDA, Saitama (JP); Soshi KAWAMURA, Saitama (JP); Yusuke YOSHIZAKI, Tokyo (JP); Takuya TANIUCHI, Saitama (JP)

(21) Appl. No.: 19/578,882

(22) Filed: Mar. 26, 2026

(30) Foreign Application Priority Data
Mar. 31, 2025 (JP) 2025-060154

(51) Int. Cl. H01M 4/1391; H01M 4/04; H01M 4/36; H01M 4/525; H01M 4/62

(52) U.S. Cl. CPC H01M 4/1391; H01M 4/0404; H01M 4/366; H01M 4/525; H01M 4/62

(57) ABSTRACT

A method for producing a positive electrode according to an embodiment of the present invention includes: a step of mechanically blending a positive electrode active material with a solid electrolyte, and classifying a resulting blended powder, to obtain a coated positive electrode active material powder; a step of mixing a solvent and a binder to obtain a binder solution; a step of kneading the coated positive electrode active material powder and the binder solution, and filtering a resulting kneaded mixture through a filter, to obtain a positive electrode mixture slurry; and a step of applying the positive electrode mixture slurry onto the positive electrode current collector, and drying it, to form the positive electrode active material layer.

### BACKGROUND OF THE INVENTION

This application is based on and claims the benefit of priority from Japanese Patent Application No. 2025-060154, filed on 31 Mar. 2025, the content of which is incorporated herein by reference.

### FIELD OF THE INVENTION

The present invention relates to a method for producing a positive electrode for secondary batteries.

### RELATED ART

In recent years, research and development of secondary batteries that contribute to energy efficiency has been conducted in order to ensure more people have access to affordable, reliable, sustainable, and advanced energy.

A positive electrode of secondary batteries includes a positive electrode current collector and a positive electrode active material layer arranged on a surface of the positive electrode current collector. The positive electrode active material layer is composed of a composition containing a positive electrode active material, a binder, a conductive aid, and the like. The positive electrode is generally produced by applying a positive electrode mixture slurry, in which positive electrode materials such as active material powder are dispersed, to the positive electrode current collector, and then drying it. Filtering the positive electrode mixture slurry before applying it on the current collector has been considered (Patent Document 1).
Patent Document 1: Japanese Unexamined Patent Application, Publication No. 2023-12689

### SUMMARY OF THE INVENTION

Meanwhile, in the field of secondary battery technology, one of problems to be solved is producing batteries with high uniformity in battery characteristics at high production efficiency. To improve production efficiency of the positive electrode, it is effective to increase the solid concentration of the positive electrode mixture slurry to form a thick positive electrode active material layer in a single application. However, according to the present inventors' studies, as the solid concentration of the positive electrode mixture slurry increases, secondary batteries including the positive electrodes obtained from that positive electrode mixture slurry tend to have reduced uniformity in the battery characteristics.

The present invention was made in view of the above problem and aims to provide a method for producing a positive electrode for secondary batteries that enables the production of secondary batteries with high uniformity of battery characteristics even when a solid concentration of a positive electrode mixture slurry is increased. Consequently, the present invention contributes to energy efficiency.

(1) A method for producing a positive electrode that includes a positive electrode current collector and a positive electrode active material layer arranged on a surface of the positive electrode current collector, the method including: a step of mechanically blending a positive electrode active material powder having an average particle diameter within a range of 3.6 μm or more and 8.6 μm or less with a solid electrolyte powder having an average particle diameter within a range of 0.1 μm or more and 1.1 μm or less, and classifying a resulting blended powder, to obtain a coated positive electrode active material powder having an average particle diameter within a range of 4.0 μm or more and 9.0 μm or less and a content of coarse particles having a particle diameter more than a length corresponding to ½ thickness of the positive electrode active material layer of 0.01% by mass or less; a step of mixing a solvent and a binder to obtain a binder solution; a step of kneading the coated positive electrode active material powder and the binder solution, and filtering a resulting kneaded mixture through a filter, to obtain a positive electrode mixture slurry with a content of coarse particles having a particle diameter more than a length corresponding to ⅔ the thickness of the positive electrode active material layer of 0.01% by mass or less; and a step of applying the positive electrode mixture slurry onto the positive electrode current collector, and drying the positive electrode mixture slurry, to form the positive electrode active material layer.

According to the method for producing the positive electrode described in (1), the content of coarse particles contained in the positive electrode mixture slurry is small, and therefore, even when a positive electrode active material concentration in the positive electrode mixture slurry is increased, a highly uniform positive electrode can be obtained. Furthermore, secondary batteries that use this positive electrode demonstrate high uniformity in battery characteristics.

(2) In the method for producing the positive electrode according to (1), the step of obtaining the coated positive electrode active material powder is performed in an inert gas atmosphere.

According to the method for producing the positive electrode described in (2), moisture is less likely to get mixed in the coated positive electrode active material powder, making it less susceptible to deterioration caused by moisture. Furthermore, even when a positive electrode active material concentration in the positive electrode mixture slurry is increased, moisture is less likely to get mixed in the positive electrode mixture slurry, and therefore, a highly uniform positive electrode can be obtained more reliably.

(3) In the method for producing the positive electrode according to (1) or (2), the binder solution is filtered through a filter in the step of obtaining the binder solution.

According to the method for producing the positive electrode described in (3), coarse particles such as binder aggregates are less likely to be mixed into the binder solution, making the positive electrode mixture slurry using that binder solution less prone to generating coarse particles. Therefore, even when a positive electrode active material concentration in the positive electrode mixture slurry is increased, a highly uniform positive electrode can be obtained more reliably.

(4) In the method for producing the positive electrode according to any one of (1) to (3), a conductive aid dispersion liquid is further added and kneaded in the step of obtaining the positive electrode mixture slurry.

According to the method for producing the positive electrode described in (4), the conductive aid is added to the positive electrode mixture slurry in a state of liquid dispersion, and therefore, the positive electrode active material layer, in which the conductive aid is uniformly dispersed, can be formed.

(5) In the method for producing the positive electrode according to any one of (1) to (4), the positive electrode mixture slurry has a solid concentration within a range of 78% by mass or more and 81% by mass or less.

According to the method for producing the positive electrode described in (5), the solid concentration of the positive electrode mixture slurry falls within the above range, and therefore, a thick layer of positive electrode active material can be formed with a single application.

(6) In the method for producing the positive electrode according to any one of (1) to (5), the step of forming the positive electrode active material layer is performed in an atmosphere with a dew point of −60° C.

According to the method for producing the positive electrode described in (6), the step of forming the positive electrode active material layer is performed in an atmosphere with the above dew point, and therefore, a highly uniform positive electrode can be obtained more reliably.

(7) In the method for producing the positive electrode according to (6), the dew point is controlled based on a surrounding atmosphere of the positive electrode active material layer.

According to the method for producing the positive electrode described in (7), the dew point of the surrounding atmosphere of the positive electrode active material layer can be precisely controlled, and therefore, the positive electrode with high uniformity can be obtained more reliably.

(8) In the method for producing the positive electrode according to any one of (1) to (7), a blending ratio of the positive electrode active material powder and the solid electrolyte powder is within a range of a mass ratio of 99:1 to 85:15.

According to the method for producing the positive electrode described in (8), the blending ratio of the positive electrode active material powder and the solid electrolyte powder is within the above range, and therefore, the surface of the positive electrode active material can be reliably coated with the solid electrolyte.

(9) In the method for producing the positive electrode according to any one of (1) to (8), the positive electrode active material powder has a BET specific surface area within a range of 0.25 m²/g or more and 1.0 m²/g or less.

According to the method for producing the positive electrode described in (9), the BET specific surface area of the positive electrode active material powder is small, and therefore, the surface of the positive electrode active material can be reliably coated with the solid electrolyte.

According to the present invention, it becomes possible to provide a method for producing a positive electrode for secondary batteries that enables the production of secondary batteries with high uniformity of battery characteristics even when the solid concentration of the positive electrode mixture slurry is increased.

### BRIEF DESCRIPTION OF THE DRAWINGS

FIG. shows a flowchart illustrating a process for preparing positive electrode mixture slurry in a method for producing a positive electrode for secondary batteries according to an embodiment of the present invention.

### DETAILED DESCRIPTION OF THE INVENTION

Hereinafter, an embodiment of the present invention will be described with reference to a drawing. However, the embodiment shown below is merely illustrative of the present invention, and the present invention is not limited to the following.

A method for producing a positive electrode for secondary batteries according to an embodiment of the present invention includes: a step of preparing a positive electrode mixture slurry; and a step of forming a positive electrode active material layer using the positive electrode mixture slurry. Hereinafter, the method for producing the positive electrode for secondary batteries according to the embodiment of the present invention will be described using a positive electrode for secondary batteries employing lithium as a charge transfer medium as an example.

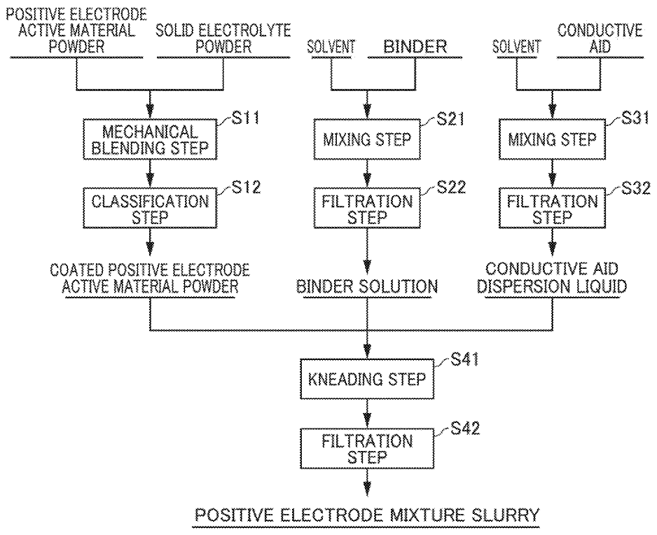

As shown in FIG. 1, the positive electrode mixture slurry is prepared in the following steps: a coated positive electrode active material powder is prepared; a binder solution is prepared; a conductive aid dispersion liquid is prepared; and the positive electrode mixture slurry is prepared.

The preparation of the coated positive electrode active material powder includes Mechanical Blending Step S11 and Classification Step S12.

In Mechanical Blending Step S11, the positive electrode active material powder and the solid electrolyte powder are mechanically blended to obtain a blended powder. Mechanical blending can be performed under dry condition. In this step, all or some parts of the positive electrode active material surfaces are coated with the solid electrolyte due to the shear stress generated by dry mechanical blending. Dry mechanical blending can be performed using methods that employ media, such as ball mills, or methods that utilize the shear force between rotating blades and the particles (positive electrode active material powder and solid electrolyte powder) inside a processing vessel, such as a high-speed agitating mixer.

The positive electrode active material powder may be a lithium compound capable of releasing lithium during secondary battery charging and absorbing lithium during discharging. Examples of positive electrode active materials include lithium-containing layered active materials, spinel-type active materials, and olivine-type active materials. Specific examples of the positive electrode active materials include lithium cobalt oxide (LiCoO₂), lithium nickel oxide (LiNiO₂), LiNiₚMn_{q}COᵣO₂ (p+q+r=1), LiNiₚAl_{q}COᵣO₂ (p+q+r=1), lithium manganate (LiMn₂O₄), heterogeneous element substituted Li—Mn spinel represented by Li₁₊ₓMn_{2-x-y}M_{y}O₄ (x+y=2, M is at least one selected from Al Mg, Co, Fe, Ni, and Zn), lithium titanate (oxides containing Li and Ti), and lithium metal phosphate (LiMPO₄, M is at least one selected from Fe, Mn, Co, and Ni).

The positive electrode active material powder may have an average particle diameter within a range of 3.6 μm or more and 8.6 μm or less. In the present embodiment, the average particle diameter is the value measured using a laser diffraction scattering method. A BET specific surface area of the positive electrode active material powder is within a range of 0.25 m²/g or more and 1.0 m²/g or less.

The solid electrolyte powder may possess lithium-ion conductivity. Examples of solid electrolytes used include sulfide solid electrolytes, oxide solid electrolytes, nitride solid electrolytes, and halide solid electrolytes. Examples of the sulfide solid electrolytes include Li₂S—P₂S₅, and Li₂S—P₂S₅—LiI. The sulfide solid electrolytes may have an argyrodite-type crystal structure. Examples of the oxide solid electrolytes include NASICON-type oxides, garnet-type oxides, and perovskite-type oxides. Examples of the NASICON-type oxides include oxides containing Li, Al, Ti, P and O (e.g., Li_{1.5}Al_{0.5}Ti_{1.5}(PO₄)₃). Examples of the garnet-type oxides include oxides containing Li, La, Zr, and O (e.g., Li₇La₃Zr₂O₁₂). Examples of the perovskite-type oxides include oxides containing Li, La, Ti, and O (e.g., LiLaTiO₃).

The solid electrolyte powder may have an average particle diameter within a range of 0.1 μm or more and 1.1 μm or less.

In Classification Step S12, the resulting blended powder is subjected to classification, to remove coarse particles. Through this step, coated positive electrode active material powder, which the positive electrode active material is coated with solid electrolyte, is obtained. The coated positive electrode active material powder has an average particle diameter within a range of 4.0 μm or more and 9.0 μm or less, and a content of coarse particles having a particle diameter more than a length corresponding to ½ thickness of the positive electrode active material layer is 0.01% by mass or less. For example, when the thickness of the positive electrode active material layer obtained by coating and drying the positive electrode mixture slurry is 200 μm, the content of coarse particles having a diameter more than 100 μm is 0.01% by mass or less.

The classification can be performed under dry condition. Dry classification can be performed using e.g., sieves or air classifiers.

To reduce moisture contamination of the coated positive electrode active material, Mechanical Blending Step S11 and Classification Step S12 may be performed under an inert gas atmosphere. Furthermore, the inert gas atmosphere may have a dew point of −60° C.

The preparation of the binder solution includes Mixing Step S21 and Filtration Step S22.

In Mixing Step S21, a solvent and binder are mixed to obtain a mixture. Mixing can be performed using a stirring mixer, for example.

Examples of the solvent include N-methyl-2-pyrrolidone (NMP), N, N-dimethylformamide (DMF), dimethylacetamide (DMA), N-methylformamide (NMF), and butyl butyrate. These solvents may be used alone or in combination of two or more types.

Examples of the binder used include fluoropolymers, nitrile polymers, polyester polymers, acrylic polymers, cellulose polymers, styrene polymers, styrene-butadiene polymers, vinyl acetate polymers, urethane polymers, and fluorinated ethylene polymers. Examples of the fluoropolymers include PVDF (polyvinylidene fluoride).

In Filtration Step S22, the resulting mixture is filtered through a filter to remove coarse particles and obtain the binder solution. The hole diameter of the filter may be within the range of, for example, 5 μm or more and 50 μm or less, or within the range of 5 μm or more and 30 μm or less.

To reduce moisture contamination of the binder solution, Mixing Step S21 and Filtration Step S22 may be performed under an inert gas atmosphere. Furthermore, the inert gas atmosphere may have the dew point of −60° C.

The preparation of the conductive aid dispersion liquid includes Mixing Step S31 and Filtration Step S32.

In Mixing Step S31, a solvent and a conductive aid are mixed to obtain a mixture. Mixing can be performed using a stirring mixer, for example.

Examples of the solvent used include NMP, DMF, DMA, and NMF. These solvents may be used alone or in combination of two or more types. The solvent may be the same as that used in the binder solution.

Examples of the conductive aid used include carbon and metal particles. Examples of carbon include carbon black, carbon nanofibers, and carbon nanotubes. These conductive aids may be used alone or in combinations of two or more types.

In Filtration Step S32, the resulting mixture is filtered through a filter to remove coarse particles and obtain the conductive aid dispersion liquid. The hole diameter of the filter may be within the range of 50 μm or more and ½ the thickness of the positive electrode active material layer or less.

To reduce moisture contamination of the conductive aid dispersion liquid, Mixing Step S31 and Filtration Step S32 may be performed under an inert gas atmosphere. Furthermore, the inert gas atmosphere may have the dew point of −60° C.

The preparation of the positive electrode mixture slurry includes Kneading Step S41 and Filtration Step S42.

In Kneading Step S41, the coated positive electrode active material powder, the binder solution, and the conductive aid dispersion liquid are kneaded to obtain a kneaded mixture. The kneading can be performed using a rotating-revolving mixer or a planetary twin-screw kneader, for example.

In Filtration Step S42, the resulting kneaded mixture is filtered through a filter to remove coarse particles. Through this step, the positive electrode mixture slurry, from which the coarse particles have been removed, is obtained. In the positive electrode mixture slurry, the content of coarse particles having a diameter more than a length corresponding to ⅔ the thickness of the positive electrode active material layer is 0.01% by mass or less. For example, when the thickness of the positive electrode active material layer obtained by coating and drying the positive electrode mixture slurry is 200 μm, the content of coarse particles having a particle diameter more than 133 μm is 0.01% by mass or less. Such a positive electrode mixture slurry can be obtained by filtering the kneaded mixture through a filter with the hole diameter of 132 μm or less.

To reduce moisture contamination of the positive electrode mixture slurry, Kneading Step S41 and Filtration Step S42 may be performed under an inert gas atmosphere. Furthermore, the inert gas atmosphere may have the dew point of −60° C.

In the step of preparing the positive electrode active material layer, the positive electrode mixture slurry is applied to the positive electrode current collector and dried to form the positive electrode active material layer.

Examples of materials for the positive electrode current collector include various metals used as positive electrode current collectors in secondary batteries, such as aluminum, aluminum alloys, stainless steel, nickel, iron, and titanium.

Examples of methods for applying the positive electrode mixture slurry onto the positive electrode current collector include spray coating, gravure printing, and doctor blade coating.

Drying can be performed by heating or vacuum drying, for example.

The positive electrode obtained as described above can be used advantageously as the positive electrode in a lithium secondary battery. The lithium secondary battery may be a non-aqueous solvent secondary battery or an all-solid battery.

According to the method for producing the positive electrode of the present embodiment, the amount of coarse particles contained in the positive electrode mixture slurry is low, and therefore, a highly uniform positive electrode can be obtained even when the solid concentration in the positive electrode mixture slurry is increased. Furthermore, the secondary battery using this positive electrode demonstrates highly uniform battery characteristics.

In the method for producing the positive electrode of the present embodiment, when preparing the coated positive electrode active material powder in an inert gas atmosphere, moisture is less likely to get mixed in the coated positive electrode active material powder, making it less susceptible to deterioration caused by moisture. Furthermore, even when the solid concentration of the positive electrode mixture slurry is increased, moisture is less likely to get mixed in the positive electrode mixture slurry, enabling more reliable production of the positive electrode with high uniformity. Similarly, when preparing the binder solution, the conductive aid dispersion liquid, and the positive electrode mixture slurry under an inert gas atmosphere, moisture is less likely to get mixed in the positive electrode mixture slurry, enabling more reliable production of the positive electrode with high uniformity.

In the preparation of the binder solution used in the method for producing the positive electrode of the present embodiment, filtering the binder solution with a filter prevents coarse particles, such as binder aggregates, from being mixed into the binder solution, making the positive electrode mixture slurry using this binder solution less prone to generating coarse particles. Consequently, even when the solid concentration in the positive electrode mixture slurry is increased, a highly uniform positive electrode can be obtained more reliably. Similarly, in the preparation of the conductive aid dispersion liquid, filtering the conductive aid dispersion liquid with a filter prevents coarse particles, such as conductive aid aggregates, from being mixed into the conductive aid dispersion liquid, making the positive electrode mixture slurry using this conductive aid dispersion liquid less prone to generating coarse particles. Consequently, even when the solid concentration in the positive electrode mixture slurry is increased, a highly uniform positive electrode can be obtained more reliably. Furthermore, in the preparation of the positive electrode mixture slurry, filtering the positive electrode mixture slurry with a filter reduces the content of coarse particles, enabling a highly uniform positive electrode to be obtained more reliably, even when the solid concentration is increased.

In the method for producing the positive electrode of the present embodiment, the conductive aid is added to the positive electrode mixture slurry in a state of dispersion liquid during the step of obtaining the positive electrode mixture slurry, and therefore, the positive electrode active material layer with uniformly dispersed conductive aid can be formed.

In the method for producing the positive electrode of the present embodiment, when the solid concentration of the positive electrode mixture slurry is within the range of 78% by mass or more and 818 by mass or less, a high solid concentration enables the formation of a thick layer of positive electrode active material with a single application.

In the method for producing the positive electrode of the present embodiment, performing the step of forming the positive electrode active material layer in an atmosphere with a dew point of −60° C. enables more reliable production of the positive electrode with high uniformity. Controlling the dew point based on a surrounding atmosphere of the positive electrode active material layer allows for precise management of the dew point of the surrounding atmosphere of the positive electrode active material layer, thereby ensuring the production of the positive electrode with high uniformity.

In the method for producing the positive electrode of the present embodiment, when the blending ratio of the positive electrode active material powder and the solid electrolyte powder is within the above range, the surface of the positive electrode active material can be reliably coated with the solid electrolyte. Furthermore, when the BET specific surface area of the positive electrode active material powder is within the above range, the surface of the positive electrode active material can be coated more reliably with the solid electrolyte, because the BET specific surface area of the positive electrode active material powder is small.

As described above, preferred embodiments of the present invention were described, but the present invention is not limited to the above embodiments, and any modifications and improvements that achieve the object of the present invention are included within the scope of the present invention. For example, in the present embodiments, the conductive aid is added in a state of dispersion liquid, but it may be mixed with the coated positive electrode active material powder in a state of powder. Furthermore, the addition of solid electrolyte powder may be incorporated as needed during Kneading Step S41.

### EXAMPLES

Hereinafter, the present invention will be described in detail with reference to Examples. However, the present invention will not be limited to these Examples.

### Example 1

(Preparation of Coated LiNi_{0.7}Co_{0.1}Mn_{0.2}O₂ Powder)

36.0 g of LiNi_{0.7}Co_{0.1}Mn_{0.2}O₂ powder (average particle diameter: 5.0 μm) and 4.0 g of argyrodite-type sulfide solid electrolyte powder (average particle diameter: 0.7 μm) were mechanically blended under dry conditions for 60 minutes at 6,000 rpm using a dry particle composing machine NOB-MINI (produced by Hosokawa Micron Corporation). The resulting blended powder was then classified using a 53 μm mesh sieve, and the fine powder retained under the sieve was collected. The coated LiNio. Co_{0.1}Mn_{0.2}O₀₂ powder was thus prepared.

### (Preparation of Binder Solution)

10.0 g of styrene-butadiene rubber (SBR) and 90.0 g of butyl butyrate solvent were stirred and mixed. The resulting mixture was then suction filtered using a 10 μm hole diameter membrane filter to remove coarse particles. The binder solution was thus prepared.

### (Preparation of Conductive Aid Dispersion Liquid)

6.8 g of acetylene black and 37.5 g of butyl butyrate solvent were stirred and mixed. The resulting mixture was then suction filtered using a 48 μm hole diameter filter to remove coarse particles. The conductive aid dispersion liquid was thus prepared.

### (Preparation of Positive Electrode Mixture Slurry)

33.3 g of the coated LiNi_{0.7}Co_{0.1}Mn_{0.2}O₂ powder, 3.8 g of the binder solution, 4.9 g of the conductive aid dispersion liquid, and 3.0 g of the solid electrolyte powder were kneaded using a rotation-revolution mixer (produced by THINKY CORPORATION). The resulting kneaded mixture was suction filtered using a 75 μm hole diameter filter to remove coarse particles. Butyl butyrate solvent was added to the kneaded mixture, in which the coarse particles are removed, to adjust the solid concentration to 80% by mass. The positive electrode mixture slurry was thus prepared.

Each step in the preparation of the coated LiNi_{0.7}Co_{0.1}Mn_{0.2}O₂ powder, the preparation of the binder solution, and the preparation of the positive electrode mixture slurry was performed in a glove box adjusted to an Ar/N₂ gas atmosphere with the dew point of −60° C.

### (Fabrication of Positive Electrode)

An aluminum foil with a thickness of 12 μm was prepared as the positive electrode current collector. The positive electrode mixture slurry described above was applied to the surface of the aluminum foil and allowed to dry. The positive electrode mixture slurry described above was subsequently applied to the rear surface of the aluminum foil and allowed to dry. Consequently, a positive electrode was fabricated with positive electrode active material layers that were formed on both the front and back surfaces. The thickness of one side of the positive electrode active material layer was 130 μm. The positive electrode was fabricated inside a glove box, which was adjusted to an atmospheric environment with the dew point of −60° C. Here, the positive electrode mixture slurry used was stored for 24 hours in a glove box adjusted to an Ar/N₂ gas atmosphere with the dew point of −60° C. and was then removed from the glove box immediately prior to the fabrication of the positive electrode. Five lots of positive electrode mixture slurry were prepared, and a total of 30 positive electrodes were fabricated, with 6 positive electrodes using the positive electrode mixture slurry of each lot.

### (Fabrication of Solid Electrolyte Layer Transfer Sheet)

A dispersion liquid of an argyrodite-type sulfide solid electrolyte (median diameter 3.0 μm) was applied to a support sheet and dried, to form an argyrodite-type sulfide solid electrolyte layer with a thickness of 40 μm, fabricating a solid electrolyte layer transfer sheet.

### (Fabrication of Negative Electrode Layer)

Electrolytic copper foil with a thickness of 10 μm was prepared as a negative electrode current collector having a negative electrode lead wire. A metal lithium foil with a thickness of 6.5 μm was laminated onto a portion of the copper foil surface, to fabricate a negative electrode layer.

### (Fabrication of All-Solid Secondary Battery)

The solid electrolyte layers of the solid electrolyte layer transfer sheets were overlayed onto the front and back surfaces of the positive electrode active material layer of the positive electrode layer, and bonding was performed using a uniaxial forming press under the following conditions: bonding pressure: 800 MPa, bonding time: 3 minutes, bonding temperature: room temperature. Subsequently, support sheets of the solid electrolyte layer transfer sheets were peeled off to obtain the positive electrode layer-solid electrolyte layer bonded body. Next, metallic lithium foils of negative electrode layers were overlaid onto the front and back surfaces of the solid electrolyte layers of the positive electrode layer-solid electrolyte layer bonded body, and bonding was performed using uniaxial forming press under the following conditions: bonding pressure: 150 MPa, bonding time: 3 minutes, bonding temperature: room temperature, obtaining an electrode laminate. The resulting electrode laminate was encased within an outer package, and the outer package was sealed to fabricate an all-solid secondary battery.

### Comparative Example 1

A positive electrode layer was prepared in the same manner as in Example 1 and an all-solid secondary battery was then fabricated using that positive electrode, except that the blended powder was not classified using a 53 μm mesh sieve in preparing the coated LiNi_{0.7}Co_{0.1}Mn_{0.2}O₂ powder.

### [Evaluation]

The AC resistance (ACR resistance) was measured at 1 KHz for 30 all-solid secondary batteries with positive electrodes fabricated from five lots obtained in Example 1 and Comparative Example 1. The results are shown in Table 1 below.

TABLE 1

| | Distribution of ACR resistance | | | |
|---|---|---|---|---|
| | | 1.0 Ω or | 1.5 Ω or | |
| | Less than | more and less | more and less | 2.0 Ω |
| | 1.0 Ω | than 1.5 Ω | than 2.0 Ω | or more |
| Example 1 | 30 | 0 | 0 | 0 |
| Comparative | 10 | 15 | 4 | 1 |
| Example 1 | | | | |

As shown in Table 1, in Example 1, where coarse particles of coated LiNi_{0.7}Co_{0.1}Mn_{0.2}O₂ powder were removed according to the present invention, ACR resistance of the resulting all-solid secondary battery is low, and its variation is small. In contrast, in Comparative Example 1, where coarse particles of coated LiNi_{0.7}Co_{0.1}Mn_{0.2}O₂ powder were not removed, the ACR of the resulting all-solid secondary battery increased, and its variation became significant. In Comparative Example 1, the increased ACR resistance variation is presumed to result from the incorporation of coarse particles of coated LiNi_{0.7}Co_{0.1}Mn_{0.2}O₂ powder into the positive electrode layer, causing non-uniformity in the electron and lithium-ion paths within the positive electrode layer. In addition, all-solid batteries with an ACR resistance of 1.5Ω or more short-circuited during the initial charge after ACR resistance measurement, rendering them incapable of charge-discharge operation. This is thought to occur because, during the production process of the all-solid battery, the pressing applied when joining the positive electrode layer and the solid electrolyte layer causes strain to develop in the positive electrode current collector and the solid electrolyte layer, originating from the coarse particles of coated LiNi_{0.7}Co_{0.1}Mn_{0.2}O₂. That is, it is believed that the resulting strain in the positive electrode current collector and solid electrolyte layer increased the ACR resistance of the all-solid battery and localized current concentration during the charging process, which likely caused the short circuit.

What is claimed is:

1. A method for producing a positive electrode that includes a positive electrode current collector and a positive electrode active material layer arranged on a surface of the positive electrode current collector, the method comprising:
a step of mechanically blending a positive electrode active material powder having an average particle diameter within a range of 3.6 μm or more and 8.6 μm or less with a solid electrolyte powder having an average particle diameter within a range of 0.1 μm or more and 1.1 μm or less, and classifying a resulting blended powder, to obtain a coated positive electrode active material powder having an average particle diameter within a range of 4.0 μm or more and 9.0 μm or less and a content of coarse particles having a particle diameter more than a length corresponding to ½ thickness of the positive electrode active material layer of 0.01% by mass or less;
a step of mixing a solvent and a binder to obtain a binder solution;
a step of kneading the coated positive electrode active material powder and the binder solution, and filtering a resulting kneaded mixture through a filter, to obtain a positive electrode mixture slurry with a content of coarse particles having a particle diameter more than a length corresponding to ⅔ the thickness of the positive electrode active material layer of 0.01% by mass or less; and
a step of applying the positive electrode mixture slurry onto the positive electrode current collector, and drying the positive electrode mixture slurry, to form the positive electrode active material layer.

2. The method for producing the positive electrode according to claim 1, wherein the step of obtaining the coated positive electrode active material powder is performed in an inert gas atmosphere.

3. The method for producing the positive electrode according to claim 1, wherein the binder solution is filtered through a filter in the step of obtaining the binder solution.

4. The method for producing the positive electrode according to claim 1, wherein a conductive aid dispersion liquid is further added and kneaded in the step of obtaining the positive electrode mixture slurry.

5. The method for producing the positive electrode according to claim 1, wherein the positive electrode mixture material slurry has a solid concentration within a range of 78% by mass or more and 81% by mass or less.

6. The method for producing the positive electrode according to claim 1, wherein the step of forming the positive electrode active material layer is performed in an atmosphere with a dew point of −60° C.

7. The method for producing the positive electrode according to claim 6, wherein the dew point is controlled based on a surrounding atmosphere of the positive electrode active material layer.

8. The method for producing the positive electrode according to claim 1, wherein a blending ratio of the positive electrode active material powder and the solid electrolyte powder is within a range of a mass ratio of 99:1 to 85:15.

9. The method for producing the positive electrode according to claim 1, wherein the positive electrode active material powder has a BET specific surface area within a range of 0.25 m²/g or more and 1.0 m²/g or less.
